(19) United States
(12) Patent Application Publication
(10) Pub. No.: US 2011/0060978 A1
(43) Pub. Date: Mar. 10, 2011

(54) Kit For Interactive Static And Online Learning

(76) Inventor: Roy D. Gross, Stamford, CT (US)

(21) Appl. No.: 12/840,769

(22) Filed: Jul. 21, 2010

Related U.S. Application Data
(63) Continuation-in-part of application No. 12/556,330, filed on Sep. 9, 2009.

(51) Int. Cl. G06F 17/00; G06F 3/00

(52) U.S. Cl. 715/202; 715/716

(57) ABSTRACT

A method, system and/or kit for storytelling connecting a static media and an electronic media in order to tell a story and to improve the storytelling process for the reader/user. The method, system and/or kit allow for portions of the original story to be skipped, and allow for the electronic media having portions of the story, clues, games, puzzles, and/or codes, such that a reader/user needs to access the electronic media to understand the original story, thus connecting the static media with the electronic media. The method, system and/or kit for storytelling further include access codes for accessing the electronic media.

### CROSS-REFERENCE TO RELATED APPLICATIONS

This application is a Continuation-In-Part of U.S. patent application Ser. No. 12/556,330 entitled Method and System for Storytelling, filed Sep. 9, 2009. The contents of U.S. patent application Ser. No. 12/556,330 filed Sep. 9, 2009 are hereby incorporated by reference.

### FIELD OF THE INVENTION

The invention relates to a method and system for a storytelling program whereby static media is combined with electronic media in order to tell a story and to improve the story telling process for a reader/user. The invention also relates to a kit for a storytelling program whereby static media is combined with electronic media and further involves requiring access codes so that the kit can be provided as a unit with one or more static media, one or more electronic media and one or more access codes.

### BACKGROUND OF THE INVENTION

For thousands of years, stories have been told via word of mouth or through written means. Stories have been modified and adapted over the years, and have been changed based upon the audience receiving the story, the person telling the story, and the history behind the story.

When telling a story, it is important for the person or media presenting the story to attract and keep the interest of the person listening to the story or reading the story. Examples of ways to keep the interest of a listener of a story have included changing the projection and tempo of the storyteller's voice, and acting out portions of the story, among other such examples. Examples of ways to keep the interest of a reader of a story have included using exclamation points, font changes, cliffhangers, and/or quotations, among other such examples.

In written form, stories have been presented in various static media formats such as books, novels, short stories, journal articles, poems, newspaper stories, magazines, religious texts, and other such static media known in the art.

With the advent of electronic media, the options for formats for storytelling have greatly increased. Electronic media may be used to tell stories using different electronic media via formats such as computers, the internet, a webpage, portable electronic devices, and other such electronic media known in the art.

However, current systems do not allow for the use of electronic media to add to and to improve the original story presented by the static media, by making the story presented by the static media more dynamic. Current systems do not take full advantage of the capabilities that electronic media offer, in order to engage the interest of a person that reads a story via a static media.

What is desired, therefore, is to find a method, system and/or kit to connect electronic media with static media. More specifically, what is desired is to provide a method, system and/or kit that allows a person to read a story via a static media, and then to use an electronic media to improve the story originally presented in the static media in various ways to engage the interest of a reader, such that the electronic media improves the original story presented by the static media.

It is further desired to provide an electronic media that is dynamic, such that a user of the electronic media may change the electronic media in order to improve the story presented by the static media and to keep the interest of a person reading the original story.

It is further desired to provide a kit for storytelling having a static media and an electronic media and one or more access codes, so that the electronic portion of the story may only be accessed after entering in or providing the access code.

It is further desired to provide a kit for storytelling having one or more static media and one or more electronic media, as well as identifiers in the one or more static media that provide access to the electronic portion of the story. This is desirable in the context of having a kit provided with multiple static media that have access to the one or more electronic media.

### SUMMARY OF THE INVENTION

Accordingly, it is an object of the present invention to provide a method, system and/or kit for using one or more electronic media to improve a story originally presented by a static media. The electronic media is accessible to the static media and can be used to improve the original story presented by the static media, and may be used to change, modify, shorten, and/or improve the original story.

Static media may be defined as a book, novel, short story, magazine, newspaper, journal, poem, or other such media that is static and non-dynamic, i.e. not changeable. Electronic media may be defined as dynamic or changeable media, such as the contents of an internet webpage, a computer program, a PDA (Personal Digital Assistant), eBook, iPod, Palm Pilot, Blackberry®, or other such electronic media known in the art, that is dynamic and changeable.

It is an object of the present invention for the electronic media to provide a portion of the original story presented by the static media. For example, the static media may contain one portion of a story, and the electronic media may contain another portion of the story that is accessed via the electronic media.

It is another object of the present invention for the electronic media to provide answers and hints for solving a series of clues presented by the static media. For example, the electronic media may provide answers to a series of clues originally presented by the static media, such that the answers to the clues are important in helping the reader understand the story presented by the static media.

It is another object of the present invention for the electronic media to present various tangents and side-stories of the original story presented by the static portion of the story, such that a reader (or “user”) may understand more about the story provided in the static media, by accessing the electronic media.

It is another object of the present invention for the electronic media to present the original story of the static media from a third person perspective, for example, electronic media may present a portion of the story from the point of view of another character in the original story, or may present the entire story from a third person point of view. This may include references to other stories that are connected to the original story presented by the static media, such as prequels, sequels, references and other such connected or related stories to the original story presented by the static media.

It is another object of the present invention for a reader to require access to the electronic media in order to completely understand the original story presented by the static media.

It is another object of the present invention for the electronic media to present a series of clues, games, puzzles, and/or quizzes such that a reader of the static media needs to solve the clues or puzzles or play games or quizzes to understand the static media.

It is another object of the present invention for the electronic media to provide various character sound bites, and to include various means to improve the story, by presenting movies, audio, written text, advertising, commercials, trailer, previews, and other such elements in the electronic media to improve the original story presented by the static media.

It is another object of the present invention for the electronic media to provide a learning system, such that a reader may learn more about the story presented by the static media, as well as more about various bits of information that a third person or educational system wishes the reader/user to know, by accessing the electronic media. The story may also involve information, such as non-fiction information or other such information.

It is another object of the present invention for the electronic media to only be accessed after a fee is paid, such that a reader needs to pay a fee to access the capabilities of the electronic media, for example, a reader is required to pay a fee in order to access a chapter or portion of the original story, of which chapter or portion is only available via the electronic media.

It is another object of the present invention for the reader to first read a static media, then to go to and access an electronic media, whereby the reader may read a portion of the story, play a game, and/or watch a movie via the electronic media, and then the reader will go back and continue to read the static media to complete the story presented by the static media.

It is another object of the present invention for third parties (authors, website administrators, etc.) to access and change the electronic media, such that the electronic media may be dynamically updated. For example, the author of the static media may access the electronic media and change the contents of the electronic media, such that the author may change a portion of the story presented via the electronic media. This is advantageous as an author may change the contents of a website displaying a chapter or portion of the original story, such that the chapter may be altered depending upon the maturity level of a reader, or the author may change the ending of the story which may only be presented by the electronic media. Additionally, an author may change clues, puzzles, or games presented by the electronic media based upon the skill level and maturity of a reader.

It is another object of the present invention for the electronic media to contain references or identifiers to certain portions of the static media. For instance, a reader may read the static media and then access the electronic media via an identifier. The electronic media may contain a return reference that may reference the previous identifier or an alternate identifier in the static media. If the reader returns to the original identifier, the reader will read the story in chronological order. If the reader returns to an alternate identifier, this may allow a reader to read the static media out of chronological order. Both embodiments allow for a connection between the static media and electronic media, as it will be impossible to read the full contents of the static media, and understand the original story presented by the static media, without consulting the electronic media.

It is another object of the present invention for the static media to present a series of clues, such that a user needs to access the electronic media in order to continue the original story presented by the static media. The answers to the clues may only be found via the electronic media.

It is another object of the present invention for the static media to be presented via an electronic format, such that the static media may be read via an electronic device, such as an eBook. Here, a separate electronic media such as a website may be accessed upon reaching an identifier in the static portion of the story. A reader will have to access (go to) this separate electronic media in order to either read a chapter or portion of the story, watch a video, and/or play a game or take a quiz, etc.

It is another object of the present invention for the static media to include buttons and other such physical devices. This will allow a book or other such static media to contain buttons, whereby a young child may press a button that may present an audio message or electronic message, via orally or visually, when the button is pressed. Such a message may contain a reference or connection to the electronic media.

It is another object of the present invention for the static media to contain a code, such that the code may only be broken by accessing the electronic media. The electronic media may contain a table and index, such that codes and/or clues, required by the static media to understand the story may only be cracked by referencing or accessing the electronic media.

It is another object of the present invention to include an access code such that the electronic media requires that the user enter in the access code prior to allowing the user access to the electronic portion of the story. This access code may be entered via the electronic media as a password in a prompt that pops up before the electronic portion of the story is able to be accessed.

It is another object of the present invention that the access code only allows access to the electronic media once, such that each access code is correlated with one-time or singular access to the electronic media. This is so multiple users cannot use the same access code to access the electronic media. Multiple access codes may be present within each static media such that a user may access the electronic media multiple times (each time via an access code providing singular access to the electronic media) to view the electronic portion of the story at different points.

It is another object of the present invention for the access code to be provided or present within the static media. It is another object of the present invention for the access code to be available separate from the static media. It is another object of the present invention for the one or more access codes to be unique.

It is another object of the present invention to provide a kit where one or more static media are provided together along with access to electronic media through access codes and identifiers. An example of this would be for story told in a classroom via a static media such as a book or textbook. The static media (multiple copies of the book in this example) and access to the electronic media may be provided as a kit to a teacher. The teacher may provide the students with the static media (multiple copies of the book) and may provide the students with different access codes for different portions of the story, which are accessed electronically. The access codes may alternatively be provided within the static media (inside each copy of the book) or may be provided separately from the static media (provided by the teacher). If separate, the access codes may be provided in a list format.

It is another object of the present invention to have different access codes be provided depending on different age groups and reading levels of the users. Thus, the same static media may be used by different age levels since the electronic portion of the story may be geared towards different age levels, reading levels and/or maturity levels. The various access codes may be sold separately and additional fees may be charged depending upon the number of access codes provided as well as the level of access that these codes provide. The level of access means the various options being able to be accessed through the access codes, such as additional chapters, games, quizzes, etc.

It is another object of the invention to provide the access codes separately from the static media. Thus, the access codes may command an additional fee to the cost of providing the static media, and the static media and codes may be provided separately or may be provided within a kit.

These and other objectives are achieved by providing a kit for telling a story comprising: a story having a static portion and an electronic portion; a static media on which the static portion of the story is read; an electronic media on which the electronic portion of the story is accessed, wherein the static portion of the story includes one or more identifiers identifying a location at which the electronic portion of the story is accessed; and one or more access codes, the one or more access codes being required by the electronic media prior to accessing the electronic portion of the story.

Each of the one or more access codes may allow for singular access to the electronic portion of the story. The electronic portion of the story may be accessed via the electronic media. The electronic portion of the story may be at least one or more of read or viewed via the electronic media.

The static media may provide a series of clues, such that the electronic media needs to be accessed in order to solve the clues and to understand the story. The electronic media may have audio and video capabilities.

The electronic media may have an interface, the interface having a series of electronic capabilities. The electronic capabilities may be selected from a group consisting of advertising materials, websites, movies, side-stories, learning systems, games, video games, clues, codes, or a combination thereof.

The contents of the electronic media may be dynamic and may be altered by a user. Access to the electronic media may require a fee.

In certain embodiments, the one or more access codes are present within the static media. For example, this involves having the access code present next to the one or more identifiers, so that a user may use the one or more identifiers to gain access to the electronic media (go to the correct webpage) and then may use or enter in the access code (a specific code) to gain access to the electronic portion of the story.

In other embodiments, the one or more access codes may be provided separately from the static media. Here, the user may use the one or more identifiers to gain access to the electronic media. The user will then receive the access code separately from the static media and will then use or enter in this access code to gain access to the electronic media to be able to gain access to the electronic portion of the story. The electronic media may have a prompt where the user must enter in the access code prior receiving access to the electronic portion of the story.

Other objectives of the present invention are achieved by providing a kit for telling a story comprising: a story having a static portion and an electronic portion; one or more static media via which the static portion of the story is read; an electronic media via which the electronic portion of the story is accessed, wherein the static portion of the story includes one or more identifiers identifying a location at which the electronic portion of the story is accessed, said one or more identifiers being present in the one more static media. There may be additional electronic media present in the kit as the identifiers may identify locations at which the electronic portion of the story is accessed, the locations being present on various electronic media.

The kit may further comprise one or more access codes, the one or more access codes being required by the electronic media prior to accessing the electronic portion of the story.

The one or more access codes may each correspond to grant singular access for a user to the electronic portion of the story. This will prevent multiple users from using the same access code more than once. Additionally, each of the one or more access codes may be unique or a unique code. The electronic media may have a database of access codes, such that when an access code is entered, it is removed from the electronic database.

In certain embodiments, each of the one or more access codes may be present within the one or more static media. This involves having the one or more access codes located next to the one or more identifiers, so that a user may use the identifier to gain access to the electronic media and then may enter in the access code to gain access to the electronic portion of the story.

In other embodiments, each of the one or more access codes may be provided separately from the one or more static media. This may be in the form of a list.

Additionally, each of the one or more access codes may be provided based upon reading levels of users of the electronic media. Access to the electronic media may also require a fee.

Other objectives are achieved by providing a method and a system for a static media and electronic media, which are connected in order to improve the story. Static media and electronic media are defined previously.

The method comprises steps for a reader to read a story presented by the static media, whereby upon coming to a certain reference point or identifier in the static media, the static media has a reference to an electronic media. The reader then is able to access the electronic media, which improves upon the original story.

More specifically, the method for reading a story comprises reading a story comprising of a static portion and one or more electronic portions, wherein the static portion is read via a static media and the one or more electronic portions is accessed via an electronic media, wherein reading the story comprises: reading the static portion until an identifier associated with a location of the electronic portion of the story is reached; using the identifier to access the electronic media associated therewith; viewing and/or listening to the electronic portion of the story via the electronic media; returning to the static portion of the story; and continuing to read the story.

The step of viewing and/or listening to the electronic portion of the story via the one or more electronic media may involve reading a portion of the story presented via the one or more electronic media.

The method involves returning to continue the original story presented by the static media to continue to read the story. Additionally, a chapter or portion of the story may only available via the electronic media and electronic portion of the story. A reader may have to access this chapter or portion in order to understand the story presented by the static media. Upon completing the chapter or portion in the electronic media, the reader may then go back to the static portion of the story presented in the static media. Multiple iterations of this event may occur such that the reader may go back and forth between the static media and electronic media in order to complete the story. Selected chapters or portions of the story may only be accessible via the electronic media, such that in order for the reader/user to understand and complete the story, the user needs to access both the static portion of the story and the electronic portion of the story, the electronic portion of the story being presented by the electronic media.

The step of multiple iterations may involve reading the static portion until another identifier associated with a location of the electronic portion of the story is reached; using the another identifier to access the one or more electronic media associated therewith; viewing and/or listening to the electronic portion of the story via the one or more electronic media; returning to the static portion of the story; continuing to read the story; and repeating the previous steps with additional identifiers.

Additionally, the electronic media may refer the reader back to the static media and more specifically to selected points in the static media. This may be done via a return reference in the electronic media. The return reference may involve returning to the first identifier in the static media, or may involve returning to an alternate identifier in the static media.

In one embodiment, the alternate identifier in the static media is later in the story than the first identifier, allowing a reader to skip a portion or certain portions of the story. This is an advantage because people with less time will be able to choose via an option in the electronic media whether they want to skip ahead and omit certain portions of the story that are not crucial to understanding the story.

A further advantage of this embodiment is to include a parental control option in the electronic media such that a parent may omit certain portions of the story that are rated above the level of the reader of the story, such as a PG-13 portion of the story being omitted for children under 13 years old. The material that is rated above the level of a reader may be located only on the electronic media. A parent may control his or her child's access to the electronic media, and thus may choose and select the material that his or her child is able to access, thus blocking his or her child from certain portions or chapters of the story that the parent deems inappropriate for the child.

In another embodiment of the present invention, the static media may have its chapters located out of chronological order. Thus, the electronic media may refer the reader to different points in the static media. This may allow the reader to read the static media even though the chapters or portions are not in order and it would not be possible to understand the story by simply reading straight through the static media. Thus, in this embodiment the reader is dependent upon accessing the electronic media to understand and complete the original story.

This embodiment critically connects the static media with the electronic media, such that, they go hand in hand to understand the story. Furthermore, this piques the reader's interest such that the reader interacts with both the static media and electronic media, making the story telling and learning process interactive and improving the story. This is especially useful for young children and helps them become engaged with both books and electronic media, which will increase a child's interest in reading as well as accessing and learning various electronic media forms.

In another embodiment, the electronic media may present the reader with a series of clues, puzzles and/or games, such that the reader needs to solve the clues, puzzles and/or games to continue the story presented by the static media. The clues, puzzles, and/or games, may be catered to the level of the reader/user. This may be done via a control element present in the electronic media.

For example, the electronic media may contain a quiz to make sure that the reader understands what he or she has read so far. In another example, the electronic media may present a series of games and puzzles that the user needs to solve in order to continue the story. In other example, the reader may play a game, such as an interactive game or even video game and needs to pass or achieve a series of events or benchmarks in order to continue the story in the static media. This engages the reader, such that the reader will be excited by the electronic media, which improves upon the original story.

Additionally, another embodiment may allow for the static media to contain a code, such that the code may only be broken by accessing the electronic media. The electronic media may contain a table and index, such that codes and/or clues, required by the static media to understand the story may only be cracked by referencing and accessing the electronic media.

In another example, the electronic media may contain various character sound bites, clips from movies, commercials, advertisements and various other audio and visual means known in the art and industry, including electronic movies, audio, written text, bright color configurations, and other such interactive means that improve the original story and excite the reader.

In another embodiment, the static media may present a series of clues that may be only solved by the electronic media. This has the additional advantage of connecting the static media and electronic media, such that to understand the original story, a reader needs to access the electronic media to solve the clues and/or problems presented in the original clues of the static media. The electronic media may pose further clues and/or questions, such that the reader is then forced to access the static media to understand the story, further connecting the static media and the electronic media.

In another embodiment of the present invention, the electronic media provides various tangents, side-stories and stories presented from a third person perspective of the original story. For example, the story presented by the static media may involve a heroic character and evil villain. The static media may tell the story from the heroic character's point of view and then the electronic media may tell a portion of the story or the entire story from the villain or third person's point of view. This allows for various side-stories to be told, such that a reader may read about a side that doesn't prevail in the original story, or such that the reader may read about the original story or sub-story from the point of view of another character.

In another embodiment, the electronic media may contain references to other stories that are connected to the original story presented by the static media, such as prequels, sequels, and other such connected stories.

For example the electronic media may contain references to other stories by the same author such that a reader may be able to download other stories by the same author by using the electronic media. An advantage to this is that the corresponding story (prequel, sequel, etc.) may be downloaded at a cost or fee. Thus, the author or original creator of the story may be able to freely market and advertise his or her other stories through the electronic media.

Additionally, the electronic media may contain advertising links and advertising material related to the original story. The author of the original story may be able to connect the story presented in the static media to other websites for other stories, movies, products, and other such items, thus creating a connection between the original story presented by the static media with various other stories, products and services that the author wishes to sell or provide to the reader. This can connect the original story presented by the static media to an entire large marketing and sales structure

In another embodiment, the electronic media may provide a learning system and interactive media. This will allow a reader to learn by accessing the electronic media, while understanding the original story presented by the static media.

For example the electronic media may be a learning website, or website relating to key concepts to be learned such as history, philosophy, or other such subjects. A reader may access the site to learn more about the original story, while also learning about various subjects picked out by his/her parents, or educational system. Thus, the electronic media may be linked to an educational third party system.

In another embodiment, the electronic media requires a cost to access. In this manner, a reader needs to pay a fee to access the capabilities of the electronic media, for example, the reader or person accessing the electronic media needs to pay a fee in order to access a chapter of the story, which is only available via the electronic media.

In another embodiment, the electronic media is dynamic and the contents of the electronic media may be changed or altered. This allows an author or controller of the electronic media to change the clues presented or to change a portion or chapter presented in the electronic media. This is advantageous because the contents of the electronic media are dynamic and may constantly be altered, allowing an author to write a secret chapter or extra chapter or portion of the story. The chapter or portion of the story may be available on the electronic media for a cost or fee.

In another embodiment, the static media may be read via an electronic media, although the contents of the static media are fixed. This will allow the static media to be a static portion of a story presented via an electronic device, such as an eBook. The reader may then access a separate electronic media to either continue to read the story, include clues about the story, or use various other embodiments described above. This separate electronic media would involve the electronic or dynamic portion of the story.

More specifically, a user reader may access a static story located on an eBook until an identifier is reached, and may then copy the identifier, which may be a URL, into the browser of a internet search engine to access the electronic media, whereby an interface is shown allowing the reader to either continue to read the story, include clues about the story, or use various other embodiments described above.

In another embodiment of the present invention, the static media may be interactive, such that it includes buttons and other such electronic elements. This may allow the static media, such as a book, to have buttons, whereby a young child may press a button that will present an audio message or electronic message orally or visually. This may include LCD lights or display devices to display the identifier for accessing the electronic media.

Other objects of the invention are achieved by providing a kit for providing information comprising: a static portion of information and an electronic portion of information; a static media on which the static portion of the information is provided; an electronic media on which the electronic portion of the information is accessed, wherein the static portion of the information includes one or more identifiers identifying a location at which the electronic portion of the information is accessed; and one or more access codes, the one or more access codes being required by the electronic media prior to accessing the electronic portion of the information.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic diagram of the static media interacting with the electronic media, whereby a portion or chapter of the original story may be accessed and/or a video/interactive module may be accessed;

FIG. 2 is a schematic diagram of the static media interacting with the electronic media and further allowing a portion of text to be skipped via access to the electronic media;

FIG. 3 is a schematic diagram of the static media interacting with the electronic media and further allowing for a parental block, such that the portion or chapter or video/interactive module may only be accessed if the parental block is lifted;

FIG. 4 is a schematic diagram of the static media interacting with the electronic media and further allowing for the static media to be accessed in a non-chronological order, such that to understand the original story a reader/user needs to access the electronic media;

FIG. 5 is a schematic diagram of the static media interacting with the electronic media and further having a control interface such that various codes, clues, puzzles, games, and/or quizzes may be selected based upon the control interface, and the control interface helps select the difficulty of these codes, clues, puzzles, games and/or quizzes based upon the skill level or maturity of the reader;

FIG. 5A is a schematic diagram of the static media interacting with the electronic media and further having a control interface such that various codes, clue, puzzles games, and/or quizzes may be selected based upon the control interface, such that the control interface has further access to a payment server and clue tier;

FIG. 6 is flow chart of the static media interacting with the electronic media, whereby the static media has a set of various clues that a reader will figure out or solve by accessing the electronic media;

FIG. 7 shows an exemplary interface of the electronic media having a text box, video box, clue links, advertising and secret story links;

FIG. 8 shows the back end of the interface of FIG. 7, allowing an author or person who maintains the exemplary interface to update the interface dynamically;

FIG. 9 is a schematic diagram of the static media interacting with the electronic media, whereby a portion or chapter of the original story may be accessed and/or a video/interactive module may be accessed, and wherein an access code may be provided by the static media;

FIG. 10 shows an exemplary interface of the electronic media having an access code query, which asks the user to enter in an access code; and

FIG. 11 is a schematic diagram showing a kit having multiple static media all connected to electronic media 1200.

### DETAILED DESCRIPTION OF THE INVENTION

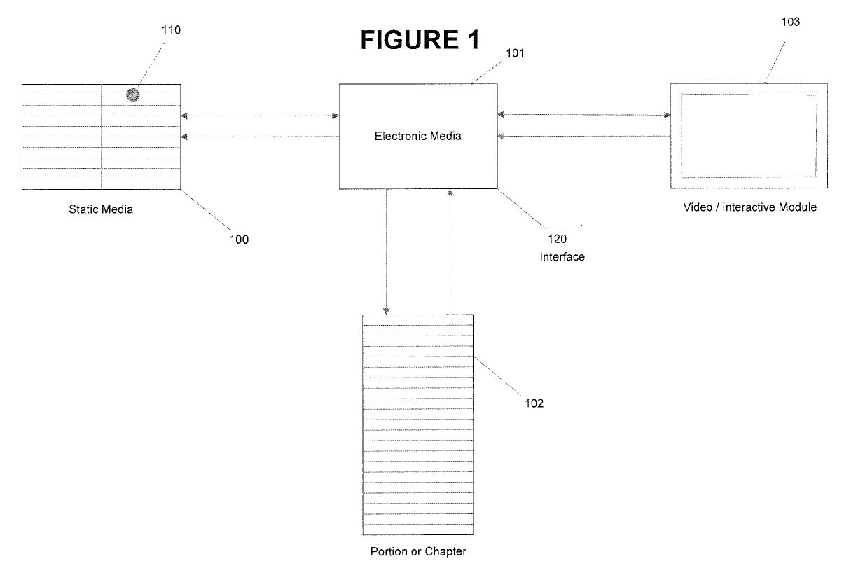

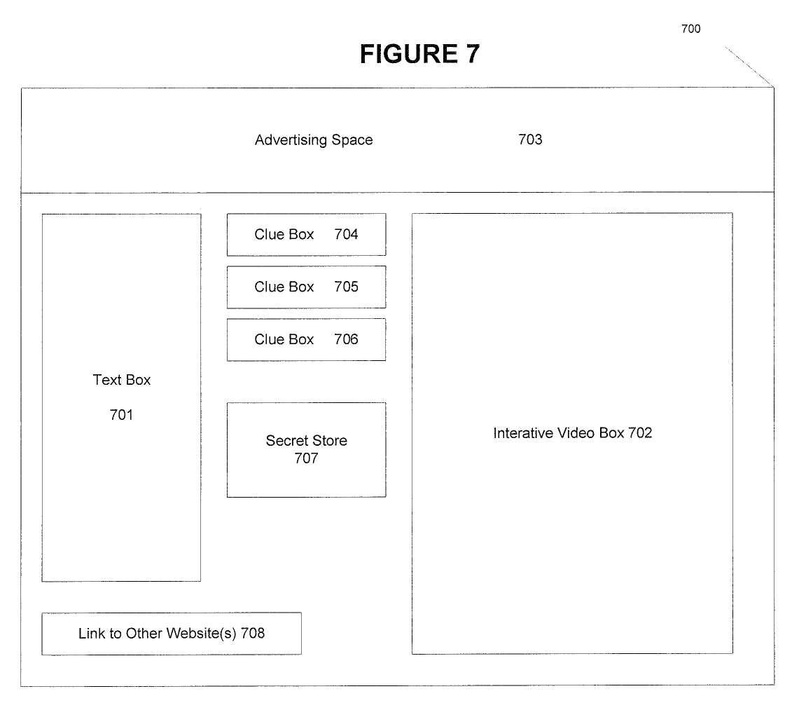

Referring to FIG. 1, static media 100 is shown in connection with electronic media 101. Static media 100 is shown, for example, as a book having identifier 110, which contains a connection to the electronic media 101. Identifier 110 may contain a static webpage address, whereby a reader or user may access a website page by entering this static address into a web browser to access the webpage or electronic media 101. The electronic media 101 typically has an interface 120, providing the reader with various options on interface 120. Typically, this interface 120 involves an interface as shown by FIG. 7. The reader may access a portion or chapter 102 of the story presented by the static media 101, allowing the reader to continue the original story. In certain embodiments, the reader may only be able to continue the story presented by the static media 100 by accessing the portion or chapter 102.

Alternatively and/or additionally, the reader may access a video/interactive module 103, which may include various clues, games, puzzles, and/or movies, thus providing an interactive module to improve the story. Video/interactive module 103 may contain a video portion of the story and may include various electronic means to improve the original story.

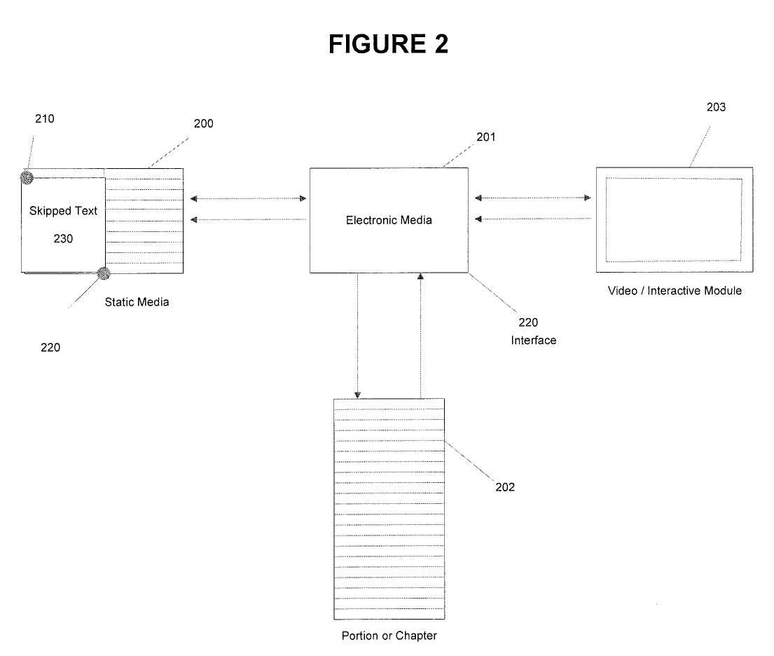

FIG. 2 shows static media 200 having identifier 210, allowing the reader to access the electronic media 201 via this identifier 210. The reader may read a portion or chapter 202 of the story and/or may access the video/interactive module 203 in this embodiment.

Of significance, is that referencing electronic media 201 will allow for a reader to skip a certain portion 230 (“skipped text”) of the static media 200, such that a reader after accessing the electronic media, will return to the static media 200 at a second reference point 220, which is a point later in the original story. This will allow a reader without much time to skip over a portion of the story that is not too relevant to the plot of the story without taking away from the general meaning of the story, thus saving the reader time.

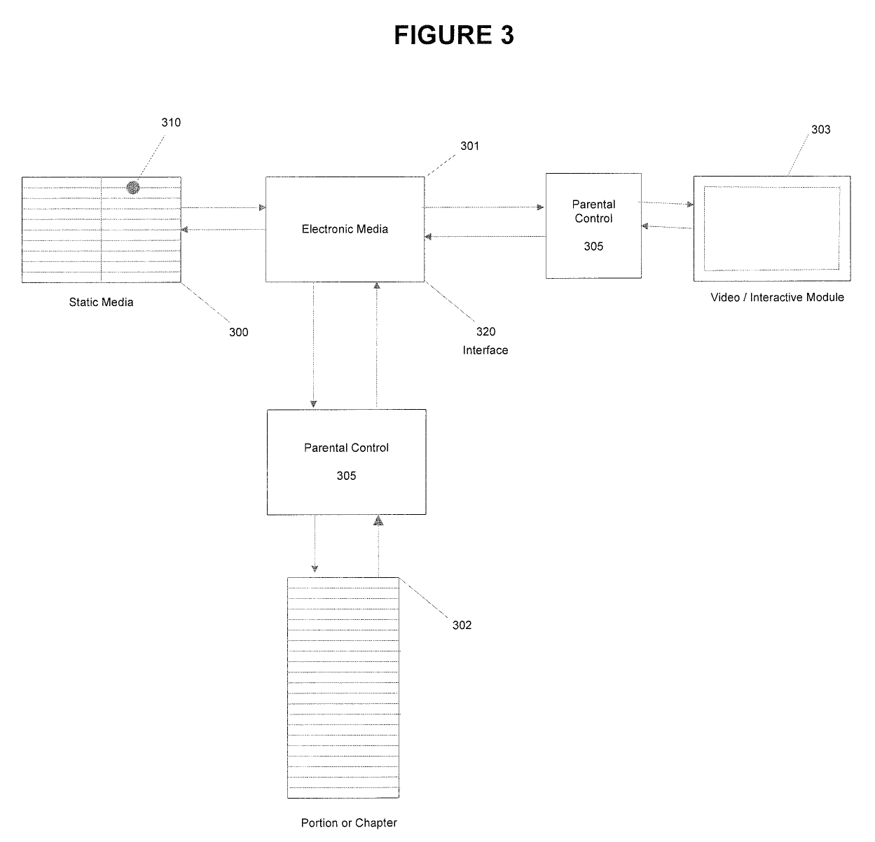

FIG. 3 shows a further embodiment having parental control/blocks 305, such that a reader may be blocked or prevented from accessing a portion or chapter 302 of the story or from accessing video/interactive module 303. Here, a parent may block a reader that is young from accessing certain portions of the story that are not appropriate for this reader. For example, a parent may block certain romantic scenes from the story or may block violent chapters and sub-chapters of the story. This may be combined with FIG. 2, such that a portion of the story presented by the static media 200/300 may be skipped. FIG. 3 also shows static media 300 in connection with electronic media 301. Static media 300 may have identifier 310, which contains a connection to the electronic media 301. Identifier 310 may contain a static webpage address, whereby a reader or user may access a website page by entering this static address into a web browser to access the webpage or electronic media 301. The electronic media 301 typically has an interface 320, providing the reader with various options on interface 320.

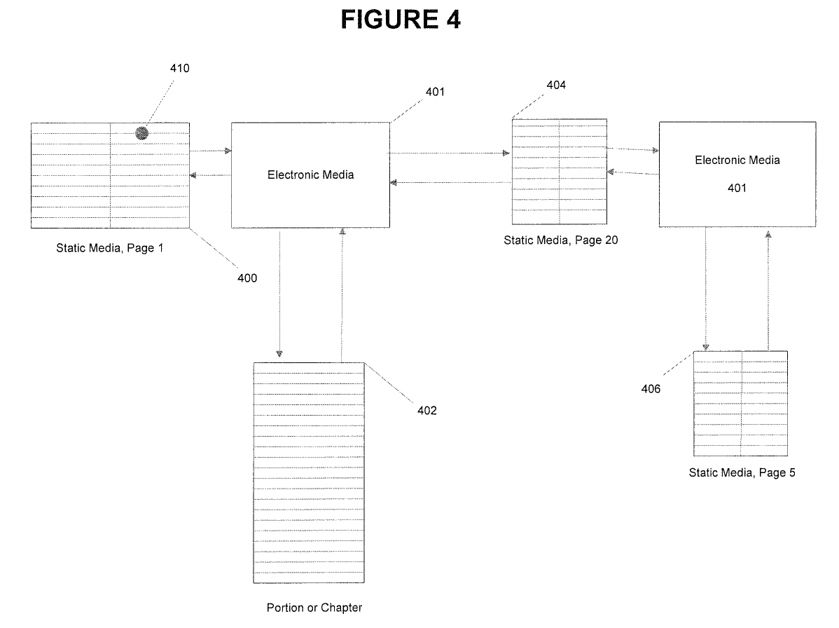

Referring to FIG. 4, an embodiment is shown whereby static media 400 has an identifier 410, whereby a connection to electronic media 401 is provided. The reader may read a portion or chapter 402 of the story, and then be returned to a later page 404 of the original story present in the static media 400 via a return reference (not shown) in the electronic media. The reader may then read this portion of the story. The reader may then again access electronic media 401, whereby another portion or chapter (not shown) may be accessed. Then, the reader/user may then be returned via another return reference (not shown) in the portion or chapter back to another page in the static media 406.

This embodiment allows for a reader to access electronic media 401 in order to understand the original story, as the original story may be presented out of chronological page order. This may be very interesting for a reader, as the original story may only be understood by accessing electronic media 401 and using electronic media 401 in combination with static media 400 to understand the original story.

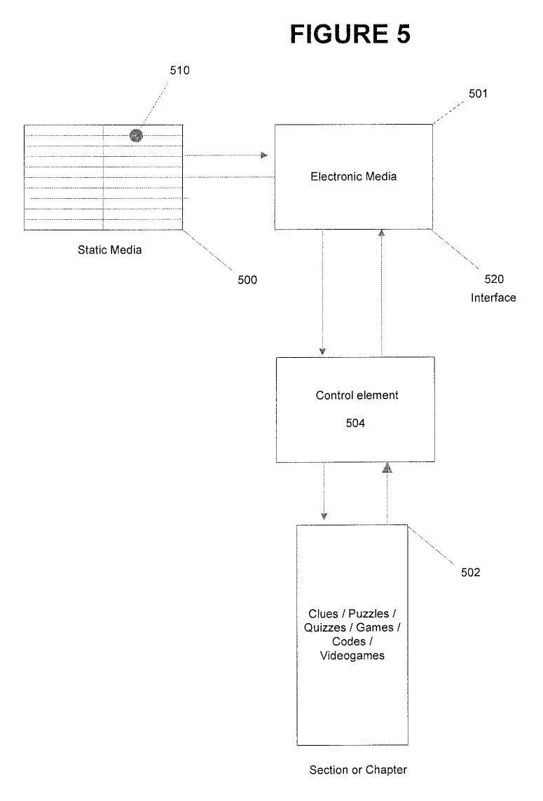

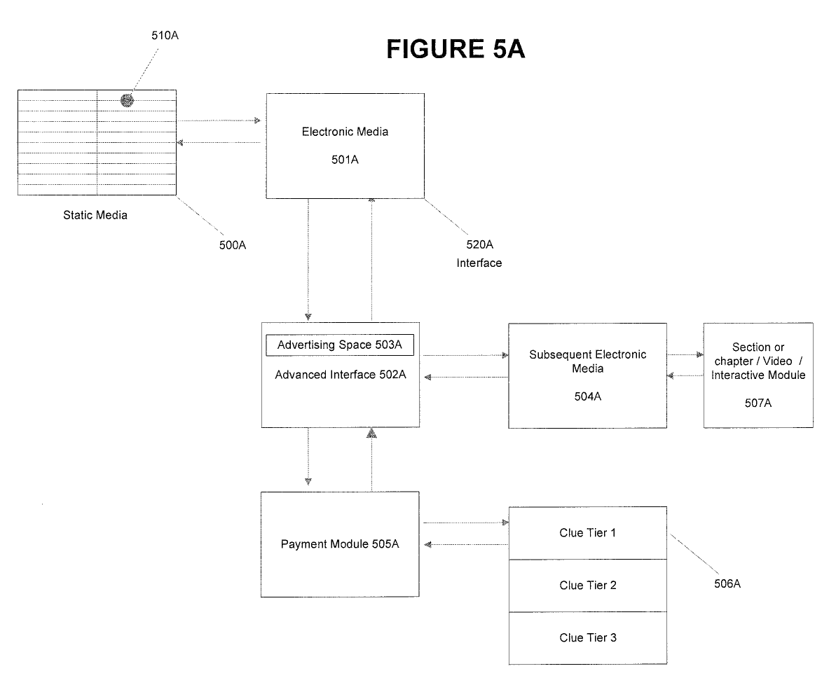

Referring to FIG. 5, static media 500 is shown in connection with to electronic media 501. In FIG. 5, interface 520 includes control element 504, which operates based upon the level of the reader. For example, control element 504 may ask the reader how old he or she is, and may ask the reader his or her educational background. The control element 504 will then select appropriate clues, puzzles, games, codes, videogames, and/or quizzes 502, such that the control element 504 will control the level of difficulty and/or maturity level of the clues, puzzles, games, codes, videogames, and/or quizzes for the reader.

This will allow age appropriate clues, puzzles, games, codes, videogames, and/or quizzes, such that to access the next part of the original story, the reader will be able to be challenged by a clue, puzzle, game, code, videogame, and/or quiz at his or her level.

FIG. 5A expands upon the embodiment shown in FIG. 5, such that access to payment server 505A is incorporated into the previous embodiment. FIG. 5A shows static media 500A having identifier 510A, which is connected to electronic media 501A. Here, when a reader accesses electronic media 501A, the reader will then access advanced interface 502A. Advanced interface 502A may have advertising space 503A, and may have access to a subsequent electronic media 504A, such that the subsequent electronic media 504A is for a prequel, sequel, or other such connecting story, for example. This may include a subsequent portion or chapter or interactive module, shown as 507A.

Additionally, access to a payment module 505A, which may be another website, webpage, or server, etc., may be required before a user accesses features of the electronic media 501A. For example, in order to access a subsequent chapter, the reader/user is required to first pay a fee.

Additionally, clue tier 506A may be presented such that the clues which the reader has to solve in order to access the next part of the original story may be presented in a tier structure. Clue tier 506A may be presented such that for a low fee the reader/user may get a difficult clue, for a higher fee the reader may get a easier clue, and for an even higher fee the reader may get an even easier or easiest clue, thus helping the reader gain access and continue the rest of the original story, by basing the clues on the amount the reader wants to pay. Additionally, the clue tier may have more or less than 3 levels as shown in FIG. 5A, and such that the clue level may also provide the answer to the question or problem being solved.

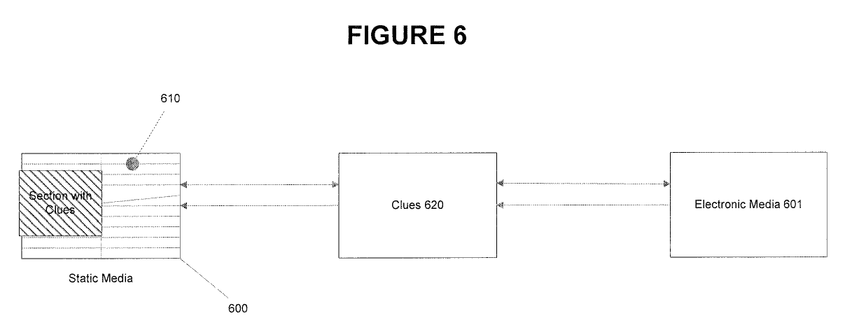

FIG. 6 shows an embodiment whereby static media 600 has identifier 610 with access to the electronic media, but also has clues 620 present through static media 600. Thus, a reader may access electronic media 601 in order to solve clues 620. This further connects electronic media 601 with static media 600.

FIG. 7 is a typical interface used with the present invention. However, other interfaces may also be used. In FIG. 7, interface 700 is shown having text box 701, allowing a reader/user to read a chapter/portion of the original story, and an interactive video box 702, such that the reader/user may watch a movie or video or other such media application. Interface 700 may also have various advertising space 703 and various links to different clues and puzzles 704-706.

Interface 700 may also have a link to a secret store 707 which may contain extra sub-stories and stories from a reference point of another character. The secret store 707 may also allow for access to a payment module or server, whereby there is an additional cost or fee in order to access the features of the interface. There may also be links to other website(s) 708.

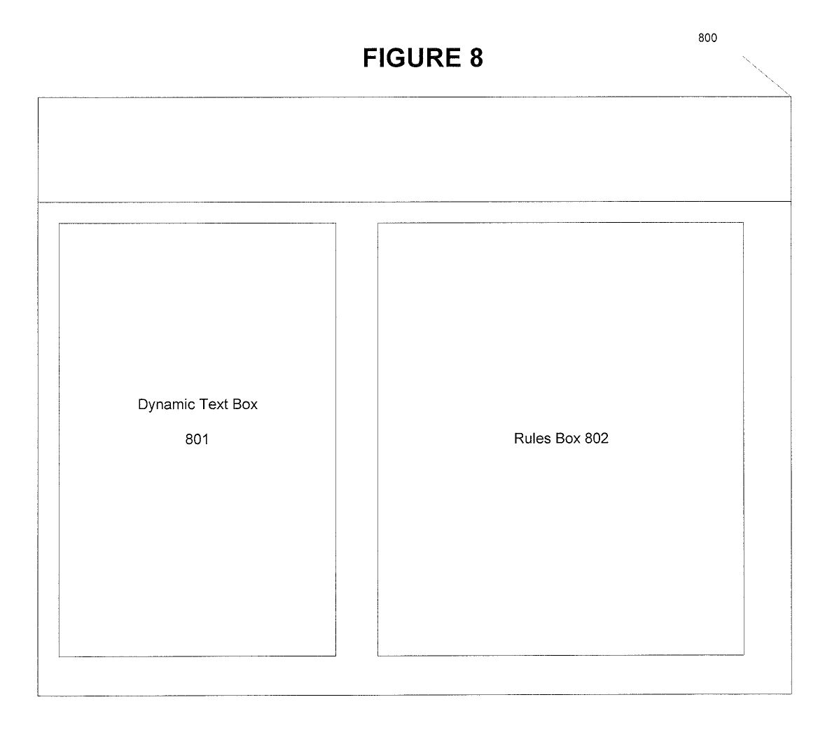

FIG. 8 shows the back end of electronic media 800. Here, an author or website owner may change the contents of text box 801 to add additional chapters or further portions of the story.

This may allow an author to promote additional literature and text, such as other stories or further portions of the story, and the author may charge the reader/user a fee or order to access these additional portions or chapters.

Additionally, an author may publish a novel piecemeal or chapter-by-chapter with this approach, as the author may continuously post new chapters as he or she goes along in the writing process.

The author may charge a fee for each new portion or chapter of the novel, such that the overall price of the novel may be increased over its final version to accommodate readers that want to read the novel continuously as it is written.

Additionally, FIG. 8 shows Rules Box 802, such that an author or website owner may change the cost structure for certain clues, may change the links to various secret chapters, may change the links on the interface, and/or may change other relevant aspects of the electronic media and/or interface of the electronic media.

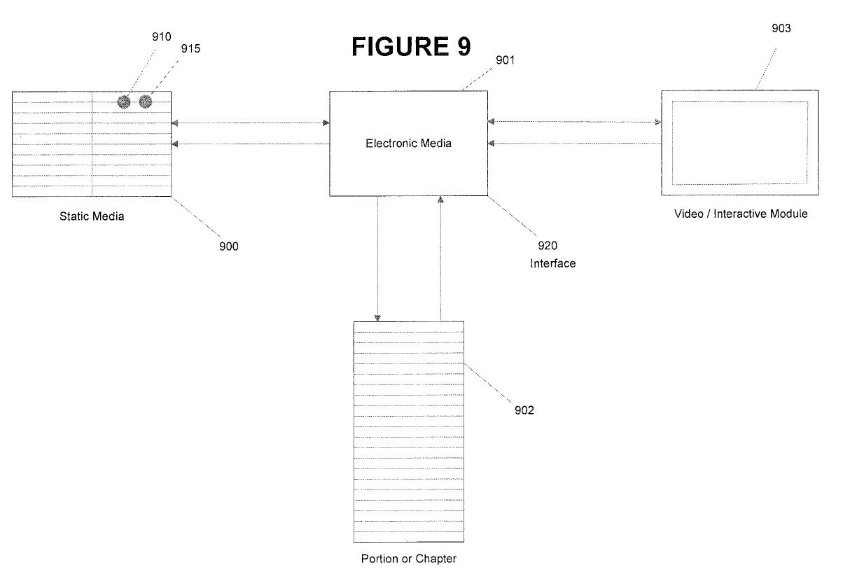

Referring to FIG. 9, static media 900 is shown in connection with electronic media 901. Static media 900 is shown, for example, as a book having identifier 910, which contains a connection to the electronic media. Identifier 910 may contain a static webpage address, whereby a reader or user may access a website page by entering this static address into a web browser to access the webpage or electronic media 901.

Additionally in this embodiment, access code 915 is shown located next to identifier 910. Access code 915 is a code that a user must enter in order to gain access to electronic media 901. Additionally FIG. 9 shows portion or chapter 902 and video/interactive module 903.

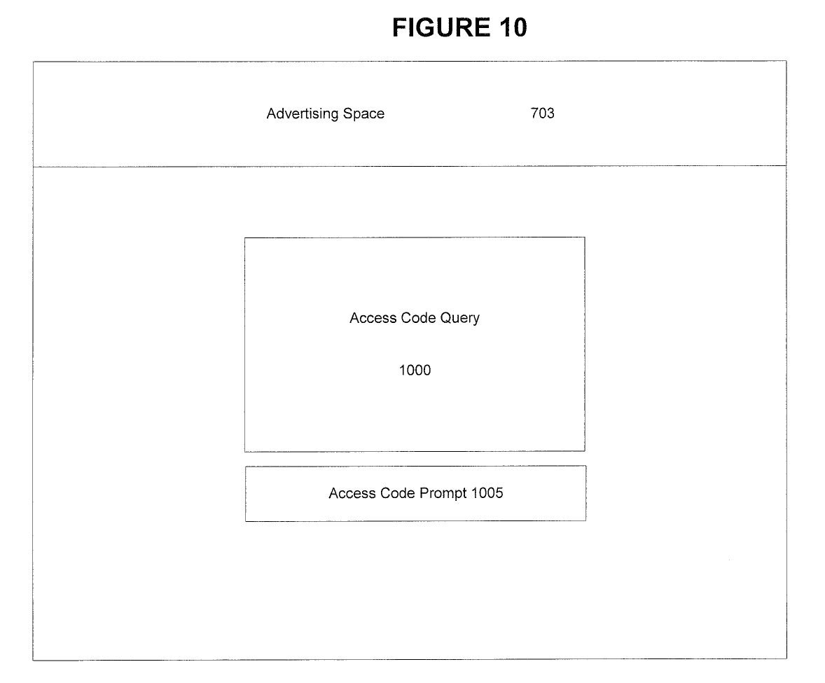

The electronic media typically has an interface 920, providing the reader with various options on interface 920. This interface 920 may involve an interface as shown by FIG. 10.

In FIG. 10, the electronic media 901 has an access code query 1000, which asks the user to enter in an access code. The user may enter the access code in the access code prompt 1005. If the access code is successfully entered, the user is then brought to the electronic media as shown via interface 700 and as provided via interface 120 in FIG. 1.

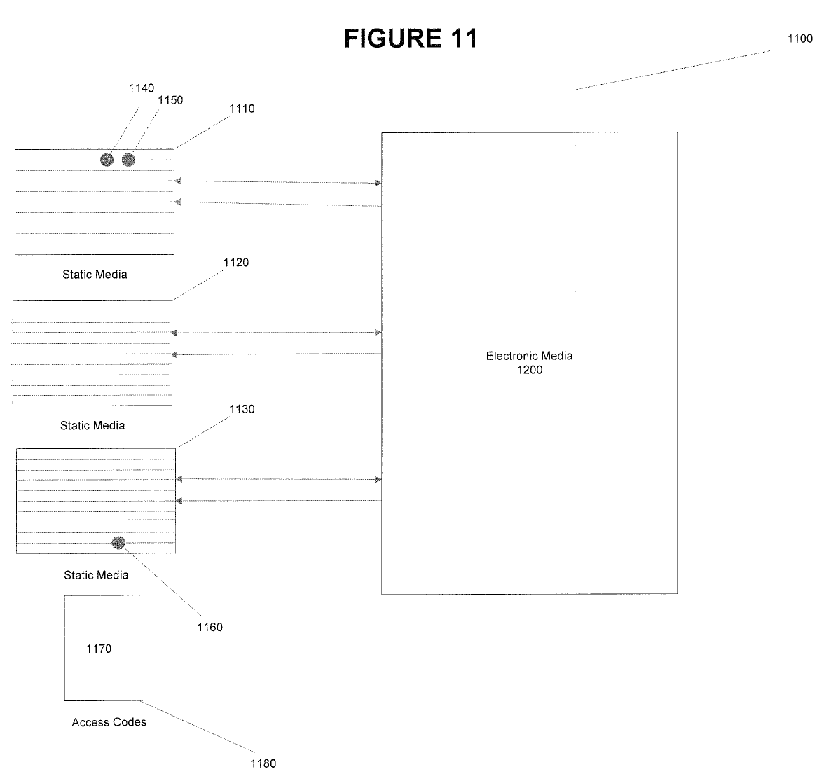

FIG. 11 shows kit 1100 of the present invention having multiple static media 1110, 1120 and 1130 all connected to electronic media 1200. Here, the embodiment is shown where multiple static media may be combined with an electronic media 1200 via access codes and identifiers.

Here, identifier 1140 and access code 1150 are shown with static media 1110. This is an example of an identifier and access codes which are present together.

In an alternative embodiment, identifier 1160 is shown with static media 1130. Access code 1170, however, is selected from a list of access codes 1180, which are provided separately from identifier 1160 and static media 1130. This is an example of access codes being separate from identifiers present in static media. A user will have to refer to the list of access codes 1180 to select an individual access code 1170 to enter in with the identifier 1160 in order to access the electronic media 1200.

Uses of the method and system of the present invention involve, among other uses, allowing young children, who require additional stimulation in order to learn how to read, a method and system of doing so. A young child, who ordinarily is not interested in reading, may combine reading with video games, websites, and portable electronic media, for example, such that the child will read and be engaged in a story and other such electronic media.

The present invention may also be used to have friends learn about each other such that a person could write a static story about themselves and then update a portion of his or her story using the electronic media. This electronic media may be only accessed by receiving a code from the author, such that the code will provide selected access to the electronic media.

The present invention may also be used for various societies, sports teams, and/or the military in order to engage the reader/user and teach them the original story and/or a series of facts and information. This would make learning the story and/or doing a new task more exciting, thus assisting in learning new information.

The present invention may be used for future stories, which have not been written as well as pre-existing stories such as biblical stories or previously published stories or novels.

The present invention may involve clues and codes, such that the reader has to predict what happens next. Additional clues and the answers to various clues may be purchased for a fee.

Additionally, quizzes may be set up, such that to get to a later part of the original story, the quizzes have to be solved. The interface may provide a tally of how well the questions were answered via the quizzes, and may provide a summary of such results upon completing of the story.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A kit for telling a story comprising:
a story having a static portion and an electronic portion;
a static media on which the static portion of the story is read;
an electronic media on which the electronic portion of the story is accessed, wherein the static portion of the story includes one or more identifiers identifying a location at which the electronic portion of the story is accessed; and
one or more access codes, the one or more access codes being required by the electronic media prior to accessing the electronic portion of the story.

2. The kit of claim 1, wherein each of the one or more access codes allows for singular access to the electronic portion of the story.

3. The kit of claim 1, wherein the electronic portion of the story is accessed via the electronic media.

4. The kit of claim 1, wherein the static media provides a series of clues, such that the electronic media needs to be accessed in order to solve the clues and to understand the story.

5. The kit of claim 1, wherein the electronic media has audio and video capabilities.

6. The kit of claim 1, wherein the electronic media has an interface, the interface having a series of electronic capabilities.

7. The kit of claim 6, wherein the electronic capabilities are selected from a group consisting of advertising materials, websites, movies, side-stories, learning systems, games, video games, clues, codes, or a combination thereof.

8. The kit of claim 1, wherein access to the electronic media requires a fee.

9. The kit of claim 1, wherein the contents of the electronic media are dynamic and may be altered by a user.

10. The kit of claim 1, wherein the one or more access codes are present within the static media.

11. The kit of claim 1, wherein the one or more access codes are provided separately from the static media.

12. The kit of claim 1, wherein the electronic portion of the story is at least one of read or viewed via the electronic media.

13. A kit for telling a story comprising:
a story having a static portion and an electronic portion;
one or more static media via which the static portion of the story is read;
an electronic media via which the electronic portion of the story is accessed, wherein the static portion of the story includes one or more identifiers identifying a location at which the electronic portion of the story is accessed, said one or more identifiers being present in the one more static media.

14. The kit of claim 13, further comprising one or more access codes, the one or more access codes being required by the electronic media prior to accessing the electronic portion of the story.

15. The kit of claim 14, wherein the one or more access codes each correspond to singular access to the electronic portion of the story.

16. The kit of claim 14, wherein each of the one or more access codes are unique.

17. The kit of claim 14, wherein each of the one or more access codes is present within the one or more static media.

18. The kit of claim 14, wherein each of the one or more access code is provided separately from the one or more static media.

19. The kit of claim 13, wherein the electronic portion of the story is accessed via the electronic media.

20. The kit of claim 13, wherein each of the one or more access codes is provided based upon reading levels of users of the electronic media.

21. The kit of claim 13, wherein access to the electronic media requires a fee.

22. The kit of claim 13, wherein the electronic portion of the story is at least one of read or viewed via the electronic media.

23. A kit for providing information comprising:
a static portion of information and an electronic portion of information;
a static media on which the static portion of the information is provided;
an electronic media on which the electronic portion of the information is accessed, wherein the static portion of the information includes one or more identifiers identifying a location at which the electronic portion of the information is accessed; and
one or more access codes, the one or more access codes being required by the electronic media prior to accessing the electronic portion of the information.
